(19) United States
(12) Patent Application Publication
(10) Pub. No.: US 2010/0164450 A1
(43) Pub. Date: Jul. 1, 2010

(54) APPARATUS, SYSTEM, AND METHOD FOR PROVIDING HIGH EFFICIENCY IN A POWER SUPPLY OVER A RANGE OF LOAD CONDITIONS

(75) Inventors: C. Charles Dishman, Raleigh, NC (US); Randhir S. Malik, Cary, NC (US)

Correspondence Address: Kunzler Needham Massey & Thorpe, 8 East Braodway, Suite 600, Salt Lake City, UT, 84111, US

(73) Assignee: International Business Machines Corporation, Armonk, NY (US)

(21) Appl. No.: 12/346,426

(22) Filed: Dec. 30, 2008

(51) Int. Cl. G05F 1/00

(52) U.S. Cl. 323/282

(57) ABSTRACT

An apparatus, system, and method are disclosed for providing high efficiency in a power supply over a range of load conditions. The apparatus includes a condition module that determines whether the power supply is in a high load state or a low load state. A high load module ensures that the load receives power through the power supply's high load power train if the load state is the high load state. A low load module ensures that the load receives power through the power supply's low load power train if the load state is the low load state. The high load power train is optimized for efficiency under high power conditions, while the low load power train is optimized for efficiency under low power conditions. The power supply thus operates with the most efficient power train for the particular load conditions, improving the net efficiency of the power supply.

### FIELD OF THE INVENTION

This invention relates to the field of power supplies, and particularly to power supplies that are highly efficient over a wide range of load conditions.

### BACKGROUND

### Description of the Related Art

Power supplies are designed to receive power from one source and condition that power to a form that is usable by another device. For example, power supplies often convert an alternating current (“AC”) signal received from a standard wall socket to a direct current (“DC”) signal that is used by an electronic device (such as a computer) that requires a DC input. Many power supplies are very efficient machines that, under ideal conditions, successfully transmit over 90% of the power they receive. However, power supplies rarely operate under ideal conditions at all times. One condition that can have a negative impact on efficiency is changes in the load presented to the power supply. The load presented by a particular device to the power supply is not always constant. The power supply designer generally has to choose a particular load state for the power supply and make it efficient at that particular load state. For example, a designer may optimize the efficiency of the power supply when it is operating under high load conditions.

However, designing the power supply to be efficient under high load conditions results in lower efficiency at low load conditions. As a result, typical power supplies generally lose between 10%-15% in terms of efficiency when the power supply is operating at less than 50% of the maximum load.

### BRIEF SUMMARY

The present invention has been developed in response to the present state of the art, and in particular, in response to the problems and needs in the art that have not yet been fully solved by currently available power supply technologies. Accordingly, the present invention provides an apparatus, method, and system that allow a power supply to operate efficiently under variable load conditions.

The apparatus is provided with a logic unit containing a plurality of modules configured to functionally execute the necessary steps for improving the efficiency of a switching power supply at variable load conditions. The apparatus includes a condition module that determines the load state of the switching power supply. The condition module determines that the switching power supply is in a high load state when the switching power supply is supplying power above a predefined power value. The condition module determines that the switching power supply is in a low load state when the power supply supplies power below the predefined power value.

In one embodiment, the apparatus also includes a high load module that supplies power to the load of the switching power supply using a high load power train when the condition module determines that the switching power supply is in high load state. The high load power train includes one or more switching power supply stages that are optimized for high efficiency in high power conditions.

In one embodiment, the apparatus includes a low load module that supplies power to the load using a low load power train when the condition module determines that the switching power supply is in the low load state. The low load power train includes one or more switching power supply stages that are optimized for high efficiency in low power conditions.

The high load power train is more efficient than the low load power train when the switching power supply is in the high load state. In one embodiment, this entails the high load power train including magnetic elements with low direct current (“DC”) losses relative to magnetic losses, and semiconductors with low drain to source resistance in the on state (“RDS(on)”) relative to inter-electrode capacitance. Similarly, the low load power train is more efficient than the low load power train when the switching power supply is in the low load state. The low load power train may include magnetic elements with high DC losses relative to magnetic losses and semiconductors with high RDS(on) relative to inter-electrode capacitance to effect such optimization.

In one embodiment, the condition module determines a measured power value for the switching power supply and compares the measured power value with the predefined power value. The power value may be an input power value, an input current value, an output power value, or an output current value. The measured power value may also be measured over an interval. In one embodiment, the predefined power value is defined as twenty percent of the maximum power capacity of the switching power supply.

In certain embodiments, the condition module continuously monitors the load state of the power supply and the high load module and the low load module respond to changes in the state of the switching power supply. As the load state of the power supply changes, the changes are detected by the condition module and the high load module and low load module respond accordingly. For example, the high load module may stop supplying power to the load using the high load power train if the condition module determines that the load state is the low load state. In one embodiment, the high load module stops supplying power to the load by stopping switching in the high load power train.

In certain embodiments, the low load module similarly stops supplying power to the load using the low load power train if the condition module determines that the load state is the high load state. The low load module may similarly stop supplying power by stopping switching in the low load power train.

Also disclosed is a system for improving the efficiency of a switching power supply at variable load conditions. The system includes a switching power supply with a high load power train that has one or more switching power supply stages optimized for high efficiency in high power conditions. The switching power supply also includes a low load power train comprising one or more switching power supply stages optimized for high efficiency in high power conditions. In certain embodiments, only one of the high load power train and the low load power train is continuously supplying power to a load connected to the switching power supply at a time. The system may also include a condition module, high load module, and a low load module as described above.

The switching power supply may receive input power from a power source and deliver it to a load that is a computer, a blade system, or an appliance. The switching power supply receives an input voltage that may be an alternating current (“AC”) or a direct current (“DC”) voltage, and the switching power supply provides a regulated output voltage that can be either an AC or a DC voltage.

Also disclosed is a method for improving the efficiency of a switching power supply at variable load conditions. The method includes determining that the switching power supply is in high load state when the switching power supply is supplying power above a predefined power value, and determining that the switching power supply is in a low load state when the switching power supply is supplying power below the predefined power value.

The method also includes supplying power to the load using the high load power train if it is determined that the power supply is in the high load state and supplying power to the load using the low load power train if it is determined that the power supply is in the low load state. The method may also include measuring a measured power value that is the input current, input power, output current, or output power to the switching power supply. In certain embodiments, the method also includes continuously monitoring the state of the switching power supply and changing the power train used in the switching power supply when a change in the state of the switching power supply is detected.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a system including a power supply, a power source, and an electronic load;

FIG. 2 is a schematic block diagram illustrating one embodiment of a power supply having an efficiency apparatus and multiple power trains;

FIG. 3 is a schematic block diagram illustrating one embodiment of an efficiency apparatus;

FIG. 4 is a schematic block diagram illustrating one embodiment of an implementation of a power supply with an efficiency apparatus;

FIG. 5 is a graph illustrating operations of a power supply having an efficiency apparatus; and

FIG. 6 is a schematic flow chart diagram illustrating one embodiment of a method for efficiently operating a power supply over a range of load conditions.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

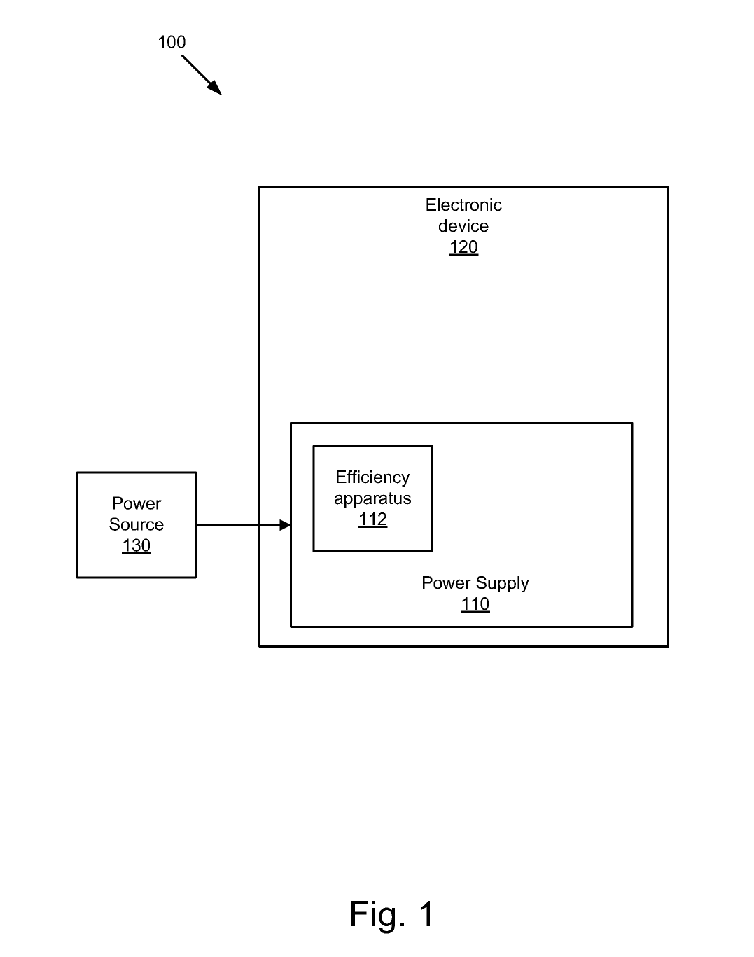

FIG. 1 depicts a system 100 in accordance with the present invention. The system 100 includes an electronic device 120, a power source 130, and a power supply 110. In accordance with the present invention, the power supply 110 includes an efficiency apparatus 112.

The power source 130 is any of a variety of devices that provide power that can be used by the power supply 110. The power source 130 may provide a direct current (“DC”) or alternating current (“AC”) output for the power supply 110. The power source 130 may be, for example, a wall outlet providing 120 V or 220 V, a generator, a three-phase or single phase system capable of providing 208V, 240 V, 480 V, or others known in the art.

The electronic device 120 can be any tangible item that requires electrical power. The power supply 110 provides the needed electrical power to the electronic device 120. The electronic device 120 may be, for example, a desktop computer, a laptop computer, an appliance such as a washer, a blade center, or others. The electronic device 120 is a variable load on the power supply 110. The power requirements of the electronic device 120, and thus the load it presents to the power supply 110, can vary. For example, a television may present a high load to the power supply 110 when it is turned on, and a low load when the television is in stand-by mode.

The electronic device 120 is a maximum load when the electronic device 120 requires the maximum power it can safely receive in order to operate. When the electronic device 120 is at its maximum load, the power supply 110 supplies maximum power to the electronic device 120. This is the maximum power capacity for the power supply 110. The load presented by the electronic device 120 can be represented as a percentage of the maximum load value or the maximum power capacity. Thus, it is not uncommon in the art to refer to a certain percentage of load when referring to the amount of power that the power supply 110 provides to the electronic device 120.

The power supply 110 receives an input signal from the power source 130 and passes an output signal to the electronic device 120. The input signal may be an alternating current (“AC”) voltage or a direct current (“DC”) voltage. The power supply 110 provides a regulated output voltage for the electronic device 120. The output voltage signal may also be an AC voltage or a DC voltage. The power supply 110 may also provide numerous output voltages. For example, a power supply 110 for a computer often provides outputs at −5 V, 3.3V, 5V, and 12V. The power supply 110 also includes an efficiency apparatus 112. The efficiency apparatus 112 enables the power supply 110 to operate efficiently over a range of load conditions.

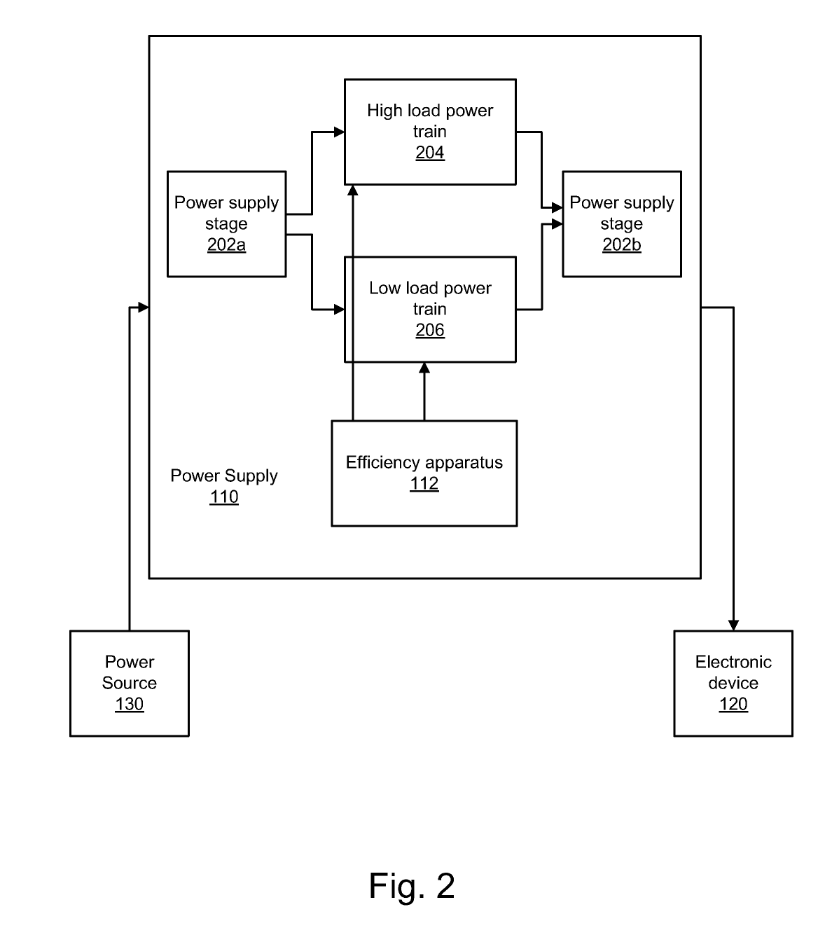

FIG. 2 shows an example of a power supply 110 having an efficiency apparatus 112. The power supply 110 receives input power from the power source 130 and provides output power in the form of a regulated output voltage to the electronic device 120. However, the load presented by the electronic device 120 can vary over a wide range.

The power supply 110 includes power supply stages 202a-b, the efficiency apparatus 112, a high load power train 204, and a low load power train 206. In one embodiment, the power supply 110 is a switching power supply that incorporates one or more switching regulators. In one embodiment, the power supply 110 includes numerous power supply stages 202a-b.

The power supply stages 202a-b can provide a variety of functions for the power supply 110. In one embodiment, the power supply stages 202a-202b may be an electromagnetic interference filtering stage and/or a rectification stage. Power supply stages 202a-b can also include boosts, bucks, buck-boosts, flybacks, Ćuks, combinations thereof, and other topologies. While FIG. 2 shows two power supply stages 202a-b, the power supply 110 is not limited to a particular number of power supply stages 202a-b. The number and type of power supply stages 202a-b can vary widely based on the needs of the power supply 110.

The power supply 110 also includes a high load power train 204 and a low load power train 206. The high load power train 204 includes one or more switching power supply stages that are optimized for high efficiency under the high power conditions that occur when the load presented by the electronic device 120 is high. High power conditions are referred to as a high load state. Optimization does not require that the high load power train 204 reduce losses to an absolute minimum; rather, it means that the high load power train 204 is more efficient than the low load power train 206 when the power supply 110 is in a high load state.

For example, when the power supply 110 is providing high levels of power due to the electronic device representing a high load, direct current losses (also referred to as copper loss) are greater than magnetic losses (also referred to as iron loss or core loss) in many circuit elements such as inductors. Similarly, at high levels of power, losses due to the drain to source resistance of a semiconductor (such as a MOSFET or power MOSFET) in the on state (commonly referred to as the RDS(on)) are larger than the losses due to inter-electrode capacitance in the semiconductor. Thus, in one embodiment, the high load power train 203 includes magnetic elements that have low DC losses relative to magnetic losses, and semiconductors with low RDS(on) relative to inter-electrode capacitance.

The power supply 110 also includes a low load power train 206. The low load power train 204 includes one or more switching power supply stages that are optimized for high efficiency under the low power conditions that occur when the load presented by the electronic device is low. Low power conditions are referred to as a low load state. Optimization does not require that the low load power train 206 reduce losses to an absolute minimum; it means that the low load power train 206 is more efficient than the high load power train 204 when the power supply 110 is in a low load state.

For example, when the power supply 110 is providing low levels of power due to the electronic device representing a low load, the magnetic losses may dominate direct current losses. Similarly, at low levels of power, the losses occasioned by the RDS(on) are smaller than the losses due to inter-electrode capacitance in the semiconductor. Thus, in one embodiment, the low load power train 203 includes magnetic elements that have low magnetic losses relative to DC losses, and semiconductors with low inter-electrode capacitance relative to RDS(on).

In one embodiment, the high load power train 204 is identical in terms of topology with the low load power train 206, the difference being the selection of elements that minimize losses for high power and low power circumstances respectively. In other embodiments, the high load power train 204 and the low load power train 206 have different topologies.

In the depicted embodiment, the efficiency apparatus 112 determines which power train to use in the power supply 110. The efficiency apparatus 112 may also monitor the load state of the power supply 110 and adjust which power train accordingly. In one embodiment, monitoring the load state involves the efficiency apparatus 112 checking if the load state is the high load state or the low load state. If the efficiency apparatus 112 determines that the power supply 110 is in the high load state, it activates the high load power train 204. If the efficiency apparatus 112 determines that the power supply 110 is in the low load state, it activates the low load power train 204. In one embodiment, the efficiency apparatus 112 activates the respective power trains by using a control signal. The efficiency apparatus 112 may also deactivate one of the power trains to ensure that only the most efficient power train is operating for the given load state.

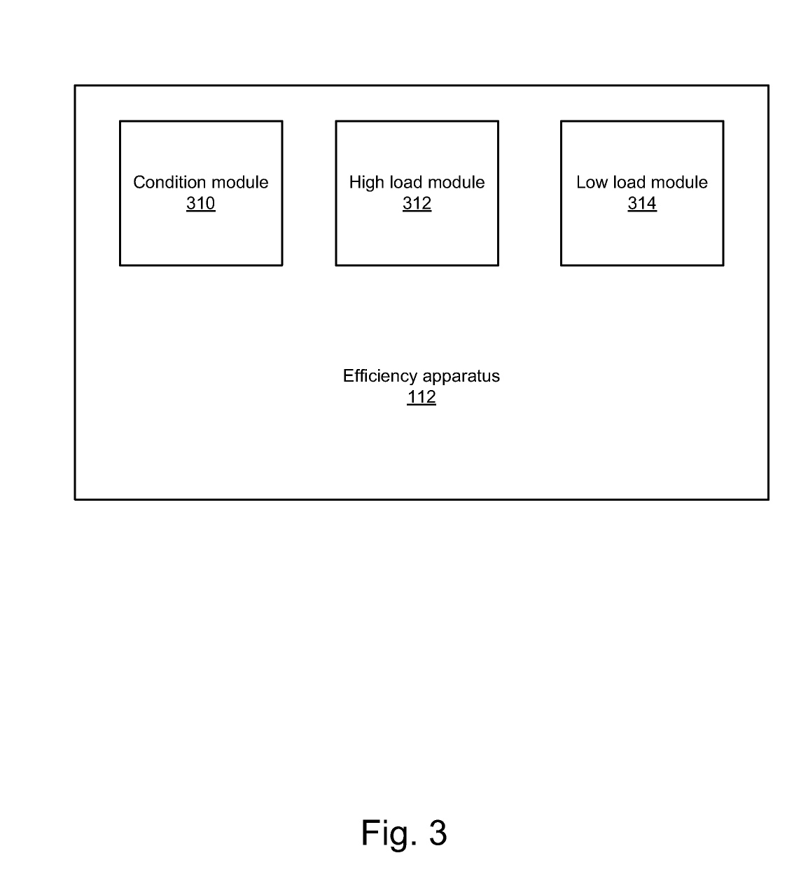

FIG. 3 shows one embodiment of an efficiency apparatus 112 that has a condition module 310, a high load module 312, and a low load module 314. In one embodiment, the condition module 310 determines that the power supply 110 is in a high load state when the power supply 110 supplies power above a predefined power value. In one embodiment, the condition module 310 determines that the power supply 110 is in a low load state when the power supply 110 is supplying power below the predefined power value.

The predefined power value may be set by the designer of the power supply 110. In certain embodiments, a user can set and adjust the predefined power value. In one embodiment, the predefined power value is some percentage of the maximum power capacity for the switching power supply. For example, the predefined power value may be twenty percent of the maximum power capacity, which can also be referred to as 20% load.

In one embodiment, the condition module 310 measures a particular power value for the power supply 110 referred to herein as a measured power value. The condition module 310 then compares this with the predefined power value. The measured power value may be measured over an interval to prevent spikes and irregularities from triggering changes in the power train selection. As used in this application, measuring over an interval encompasses a variety of methods to take measurements and affix an appropriate value for some period of time. For example, an average or a median value can be used. The measured power value may be sampled and an average taken to determine the value. In some embodiments, a single measurement may be taken at regular intervals. In addition, resistive-capacitive (“RC”) time constants can be used to take what is the equivalent of an average power value.

The term “measured power value”, as used herein, refers to any measurement that relates to the power being provided by the power supply 110. For example, the measured power value may be a measurement of the input power to the power supply 110. In other embodiments, the measured power value is a measurement of the input current to the power supply 110. The measured power value may be a measured output current or a measured output power.

In certain embodiments, the condition module 310 measures both input current and input voltage at the input terminals of the power supply 110. In other embodiments, the condition module 310 measures the input power at a different location in the power supply 110 (such as after rectification and filtering). The condition module 310 may simply measure input current and assume an input voltage in order to determine actual power. In other embodiments, the condition module 310 measures input current and does not extrapolate an input power. The condition module 310 may alternatively measure the measured power value at the output or other location in the power supply 110 where the current or the voltage can be used to determine whether the power supply 110 is in the high load state or the low load state.

In certain embodiments, the condition module 310 continuously monitors the load state of the power supply 110. The load state, in one embodiment, includes the high load state and the low load state. Continuous monitoring, as used in this application, refers to continuing to monitor the load state of the power supply 110 after an initial determination of the load state. Thus, if the condition module 310 determines that the power supply 110 is operating in the high load state, it continues to monitor the power supply 110 such that a change in the load state is detected. Continuous monitoring does not require that there be no gaps in the monitoring. For example, the condition module 310 may continuously monitor the load state by taking samples at intervals.

The efficiency apparatus 112, in one embodiment, also includes a high load module 312. The high load module 312 supplies power to the load of the switching power supply using the high load power train 204 when the condition module 310 determines that the load state is the high load state. In one embodiment, the high load module 312 supplies power to the load using the high load power train 204 by turning on the switching in the high load power train 204. In one embodiment, the high load module 312 turns on switching by activating one or more pulse width modulators that control the switches in the high load power train 204. The high load module 312 may activate the pulse width modulators using a control signal.

In one embodiment, the high load module 312 responds to changes in the load state of the power supply 110 that are detected by the condition module 310. Thus, the high load module 312 may activate the high load power train 204 if the load state of the power supply 110 changes from the low load state to the high load state. Similarly, the high load module 312 may deactivate the high load power train 204 if the load state of the power supply 110 changes from the high load state to the low load state. The high load module 312 may deactivate the high load power train 204 through a control signal that turns off switching in the high load power train 204. As a result, the high load module 312 stops supplying power to the load attached to the power supply 110 using the high load power train 204 when the condition module 310 determines that the load state is the low load state. In one embodiment, the switches are left open when the high load power train 204 is not active.

The efficiency apparatus 112 also includes a low load module 314 that supplies power to the load of the switching power supply 110 using the low load power train 206 when the condition module 310 determines that the load state of the power supply 110 is the low load state. The low load power train 206 is optimized for high efficiency in low power conditions.

In one embodiment, the low load module 314 turns on switching by activating one or more pulse width modulators that control the switches in the low load power train 206. As with the high load module 312, the low load module 314 may activate the pulse width modulators using a control signal. In certain embodiments, the low load module 314 also responds to changes in the load state of the power supply 110 that are detected by the condition module 310. The low load module 314 may activate the low load power train 206 if the load state of the power supply 110 changes from the high load state to the low load state. Similarly, the low load module 314 may deactivate the low load power train 206 if the load state of the power supply 110 changes from the low load state to the high load state.

In one embodiment, only one of the high load power train 204 and the low load power train 206 is continuously supplying power to the load at a particular time. In such an embodiment, when one of the power trains is activated, the other is deactivated. For example, when the power supply 110 is in the high load state, the high load module 312 turns switching on in the high load power train 204 and the low load module 314 turns switching off in the low load power train 206. Similarly, when the power supply 110 is in the low load state, the low load module 314 turns switching on in the low load power train 206 and the high load module 312 turns switching off in the high load power train 204.

In additional embodiments, the high load module 312 and low load module 314 activate and deactivate their respective power trains by physically connecting and disconnecting the power trains. For example, in one embodiment, relays are used to connect and disconnect the power trains, thus activating and deactivating the power trains according to the load state of the power supply 110. In other embodiments, additional switches are used to connect and disconnect the power trains from the rest of the power supply 110. Thus, the high load module 312 can use a variety of approaches to supply power to the load when the power supply 110 is in the high load state, and can also use a variety of approaches to stop supplying power to the load when the power supply 110 is in the low load state. The low load module 312 can similarly use a variety of approaches to supply and stop supplying power.

Continuously supplying power to the load entails providing regular, regulated output power to the load for more than a transitional period. For example, when the low load power train 206 is deactivated and the high load power train 204 is activated, there may be a transitional period when both power trains provide some power to the load. The low load power train 206 may release some energy stored during operation to the load after it is deactivated. Such transient signals and releases of energy to the load after being deactivated is not continuously supplying power to the load. There may be a brief transitional period for the activated power train to ramps up while the deactivated power train ramps down.

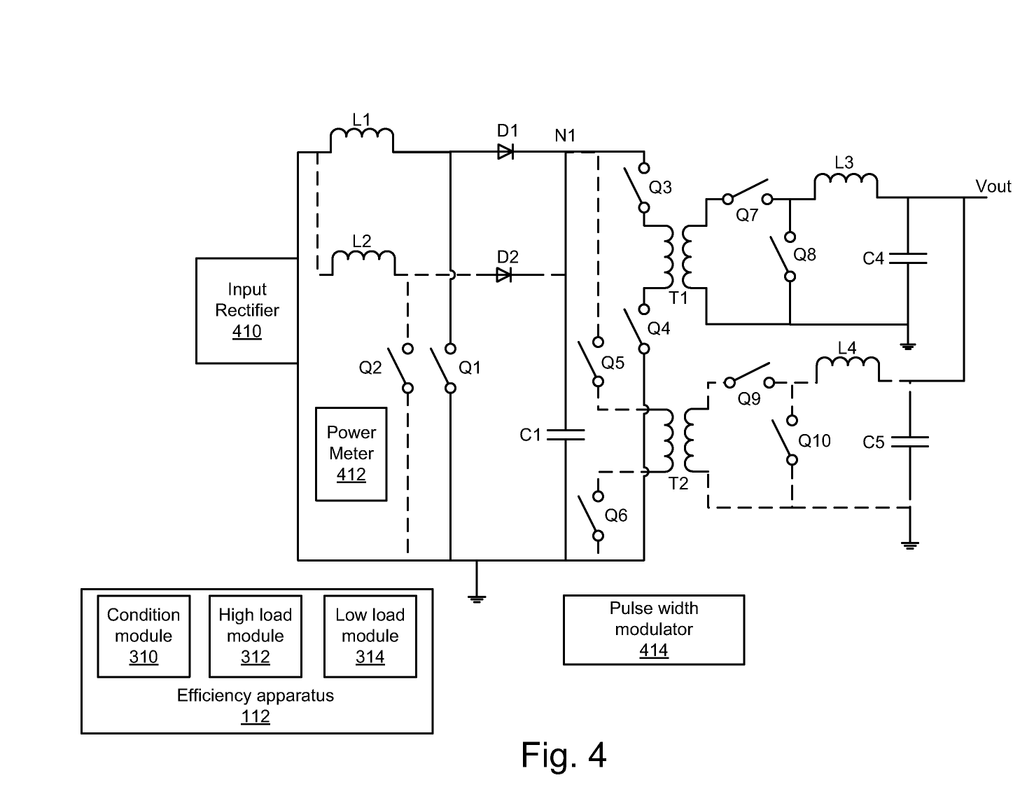

FIG. 4 illustrates one embodiment of a power supply incorporating an efficiency apparatus 112. The power supply 110 illustrated in FIG. 4 is simply one embodiment of a power supply 110. The actual topology, stages, and function of a power supply 110 may vary from that shown in FIG. 4. The power supply 110, as shown, includes an input rectifier 410 that converts an input AC signal to a DC signal. In one embodiment, the power supply 110 may also include a filter that filters electromagnetic interference.

FIG. 4 illustrates a power supply 110 with a boost stage that boosts the voltage at the node N1 to a predetermined value. In one embodiment, the node N1 is boosted to 400 V DC. Transformers T1 and T2 couple the primary stage and the secondary stage and allow energy to transfer from one side to the other. The secondary converts the voltage at N1 to the voltage at Vout. In one embodiment, Vout is 12 V DC.

FIG. 4 also shows switches Q1-Q10. These switches may be semiconducting devices such as metal-oxide-semiconductor field-effect transistors (MOSFETs) or bipolar junction transistors (BJTs). Some embodiments use power MOSFETs for the switches. The switches can be turned on (closed) and off (open) by changing the voltage at the MOSFET terminals. In a power supply 110, the switches are often turned off and on at a high frequency with respect to the frequency of the input signal. For example, switches may have a switching rate of approximately 100 kHz.

Also shown is a pulse-width modulator 414. The pulse-width modulator 414 controls the switching rate of the switches. The power supply 110 may have multiple pulse-width modulators 414 to control the switching rates for the switches Q1-Q10. The pulse width modulator 414 may receive input from other devices such as the efficiency apparatus 112. The efficiency apparatus 112 and the pulse width modulator 414 may, in certain embodiments, be physically separate or part of the same physical device.

In FIG. 4, the high load power train 204 includes the components L1, Q1, D1, and C1 configured as a boost, and the components C1, Q3, T1, Q4, Q7, Q8, L3, and C4 configured as a DC-DC regulator. In one embodiment, components for the high load power train 204 are selected to minimize losses associated with high power operation. For example, the high load power train 204 may operate under high current conditions; as such, components are selected to minimize the DC losses. For example, the magnetic structures L1, T1, and L3 are selected such that they have low DC or copper losses, but suffer from higher magnetizing losses. In one embodiment, the switches in the high load power train 204 have very low drain to source resistance in the on state (“RDS(on)”) but relatively high inter-electrode capacitances. In one embodiment, the components of the high load power train 204 are selected to minimize losses under high power conditions.

The low load power train 206 includes the components L2, Q2, D2, and C1 configured as a boost, and the components Q5, Q6, T2, Q9, Q10, L4, and C5 configured as a DC-DC regulator. In one embodiment, the components for the low load power train 206 are selected to minimize losses at low power operation. For example, in low power conditions, switching losses and magnetic losses may swamp the relatively small DC losses if the current at low power is small. In such an embodiment, a designer may choose components to minimize magnetic losses and switching losses relative to DC losses.

As shown in FIG. 4, in certain embodiments, the high load power train 204 and the low load power train 206 share the same element. For example, both the high load power train 204 and the low load power train 206 include the capacitor C1. In one embodiment, the high load power train 204 and the low load power train 206 share elements that are relatively insensitive to changes in power in terms of efficiency. In other embodiments, the low load power train 206 and the high load power train 204 do not share any elements in common.

In FIG. 4, the high load power train 204 and the low load power train 206 also share the same topology. In alternative embodiments, the high load power train 204 and the low load power train 206 have different topologies. In certain embodiments, topologies are chosen that enhance the efficiency of the particular power train at the relevant power levels.

In one embodiment, the power supply 110 includes a power meter 412 that measures a power value for the power supply 110. The power meter 412 may measure input power at the input terminal of the power supply 110 or, alternatively, at another point in the power supply 110. For example, the power meter 412 may measure power after the input rectifier 410.

As noted above, measurements other than input power may be used to determine the load state of the power supply 110. For example, the power meter 412 may be used to measure output power. The power meter 412 can also be implemented at any point in the power supply 110 where the power readings accurately indicate the load state of the power supply 110. In other embodiments, rather than a power meter 412, a current sensor or voltage sensor is used to measure the measured power value.

FIG. 4 also shows an efficiency apparatus 112 as described above. In one embodiment, the efficiency apparatus 112 is a microcontroller. In other embodiments, the efficiency apparatus 112 is a hardware circuit, a processor executing instructions stored on a memory device, or other device capable of executing the functions described above.

In one embodiment, the condition module 310 receives input from the power meter 412. The condition module 310 uses the input from the power meter 412 to determine whether the power supply 110 is in a high load state or a low load state. In one embodiment, the condition module 310 records the input power readings from the power meter 412 over an interval and averages the input power readings to determine the measured power value. The condition module 310 compares the measured power value with a predefined power value that represents some percentage of the maximum power capacity for the power supply 110.

If the comparison module 310 determines that the measured power value is above the predefined power value, the high load module 312 activates the high load power train 204. In one embodiment, activating the high load power train 204 involves the high load module 312 sending one or more signals to the pulse width modulator 414 instructing the relevant pulse width modulators (for example, pulse width modulator 414) to initiate switching for components Q1, Q3, Q4, Q7, and Q8. The low load module 314, in one embodiment, deactivates the low load power train 206 in response to the comparison module 310 determining the measured power value is above the predefined power value. Thus, the low load module 314 may instruct the relevant pulse width modulators to stop switching for components Q2, Q5, Q6, Q9, and Q10. In one embodiment, the switches Q2, Q5, Q6, Q9, and Q10 are left open to deactivate the low load power train 206 and stop power flow through the low load power train 206.

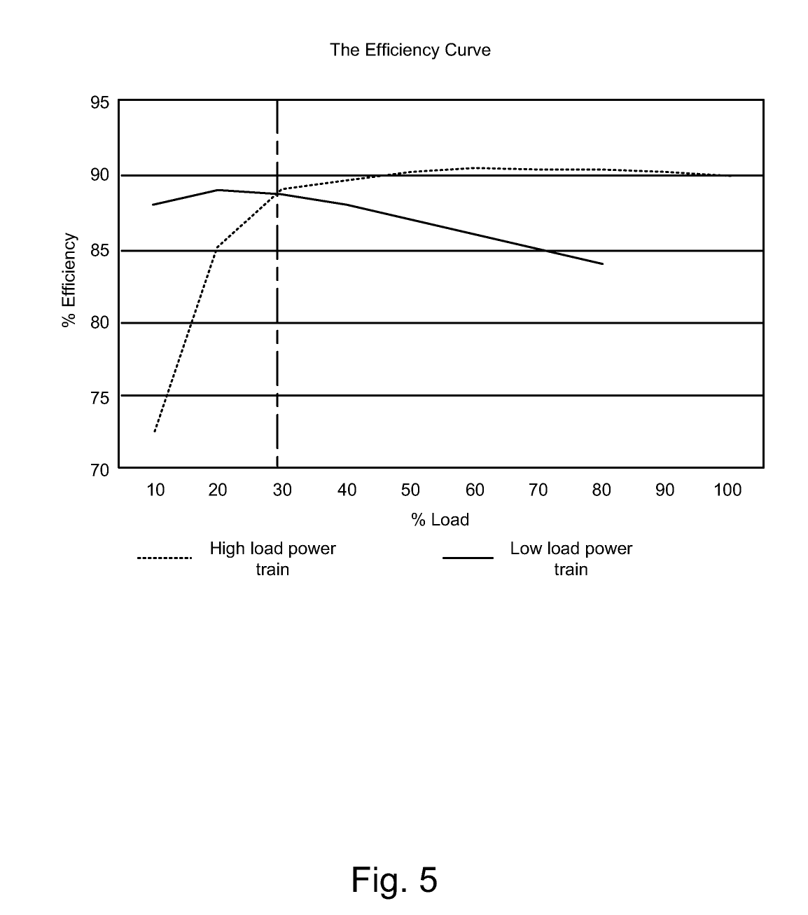

FIG. 5 shows a graph demonstrating the results of one particular implementation of a power supply 110 having a high load power train 204 and a low load power train 206. The x-axis represents the percentage of the load, or the percentage of the maximum power capacity of the switching power supply 110, at which the power supply 110 is operating. Thus, when the power supply 110 is operating at 100% of its load, or at its maximum power capacity, the power supply 110 is approximately 90% efficient using the high load power train 204. However, when the power supply 110 is at the low end of its range, such as 10% of the load, its efficiency using the high load power train 204 drops to around 72%.

In contrast, the power supply 110 using the low load power train 206 is almost 90% efficient at low loads, but drops to below 85% efficiency at higher loads. Thus, in one embodiment, of the present invention, the predefined power value is set to approximately 30% of the maximum power capacity of the power supply 110. This allows the power supply 110 to take advantage of the improved efficiency offered by using the low load power train 206 below the 30% mark, and the improved efficiency associated with using the high load power train 204 above the 30% mark.

In one embodiment, the predefined power value is set to the % load value where the two efficiency curves intersect. In other embodiments, the predefined power value is set to a different % load value. A variety of considerations may lead a designer to set the predefined power value to a point other than the point of intersection. In one embodiment, the predefine power value is selected such that the overall efficiency curve of a power supply 110 having a high load power train 204 and a low load power train 206 is relatively flat. A power supply 110 implementing the efficiency apparatus 112 and associated power trains can thus offer superior efficiency over a wide range of load conditions.

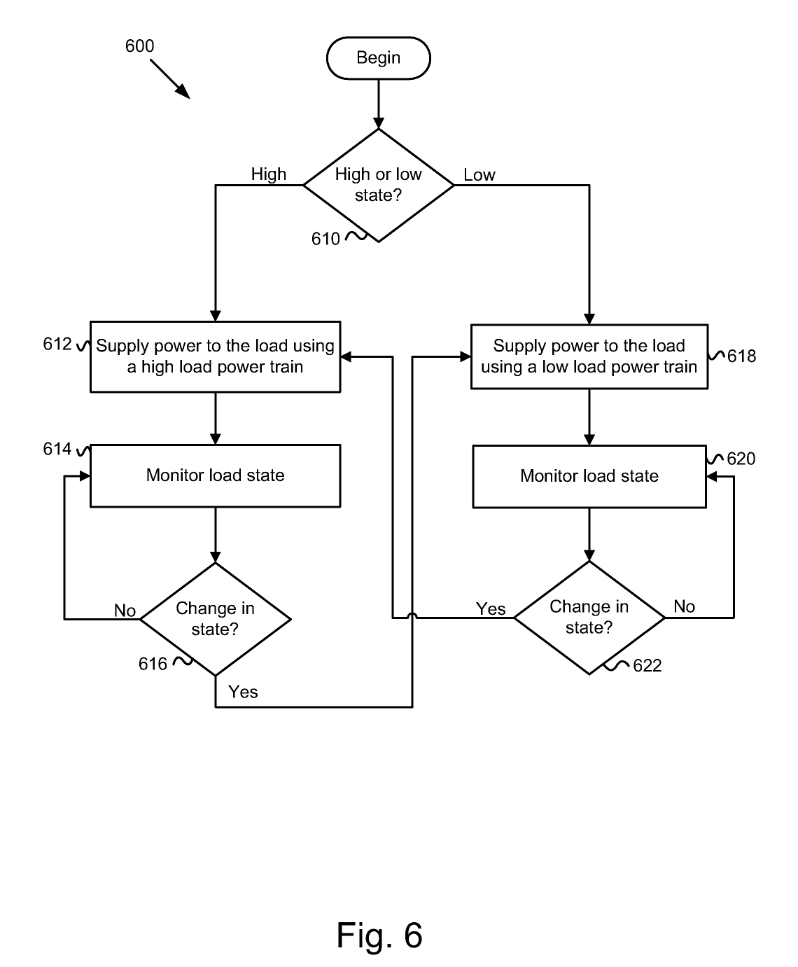

FIG. 6 is an illustration of a method 600 for improving the efficiency of a power supply 110 under variable load conditions. The method begins with determining 610 whether the load state of the power supply 110 is the high state or the low state. In one embodiment, the condition module 310 determines the load state of the power supply 110. If the power supply 110 is in the high load state, power is supplied 612 to the load using the high load power train 204. In one embodiment, the high load module 312 supplies power to the load using the high load power train 204 by activating switching in the high load power train 204. If the load state is the low load state, power is supplied 618 to the load using the low load power train 206. In one embodiment, the low load module 314 supplies power to the load using the low load power train 206 by activating switching in the low load power train 206.

Once the power supply 110 is providing power to the load using the high load power train 204, the method involves monitoring 614 the load state of the power supply 110. In one embodiment, the condition module 310 monitors 6114 the load state. If there is no change in the load state, the condition module 310 continues monitoring. When a change is detected, then power is supplied 618 to the load using the low load power train 206. In one embodiment, this involves activating the low load power train 206 and deactivating the high load power train 204. Similar steps occur when the power supply 110 is using the low load power train 206 and a change in the load state is detected.

In one embodiment, the method 600 involves continuously monitoring the load state of the power supply 110 and adjusting the power train used to deliver power to the load in response to changes in the load state. As a result, the overall efficiency of the power supply 110 as it ranges over a variety of load conditions is improved.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for improving the efficiency of a switching power supply at variable load conditions, the apparatus comprising:
a condition module that determines that a switching power supply is in a high load state in response to the switching power supply supplying power above a predefined power value and that determines that the switching power supply is in a low load state in response to the switching power supply supplying power below the predefined power value;
a high load module that supplies power to a load of the switching power supply using a high load power train in response to the condition module determining that a load state of the switching power supply is the high load state, wherein the high load power train comprises one or more switching power supply stages optimized for high efficiency in high power conditions; and
a low load module that supplies power to the load of the switching power supply using a low load power train in response to the condition module determining that the load state is the low load state, wherein the low load power train comprises one or more switching power supply stages optimized for high efficiency in low power conditions.

2. The apparatus of claim 1, wherein the high load power train is more efficient than the low load power train when the switching power supply is in the high load state.

3. The apparatus of claim 1, wherein the low load power train is more efficient than the low load power train when the switching power supply is in the low load state.

4. The apparatus of claim 1, wherein the condition module measures a measured power value for the switching power supply and compares the measured power value with the predefined power value.

5. The apparatus of claim 4, wherein the predefined power value is twenty percent of a maximum power capacity for the switching power supply.

6. The apparatus of claim 4, wherein the power value is one of an input power value, an input current value, an output power value, and an output current value.

7. The apparatus of claim 4, wherein the measured power value is measured over an interval.

8. The apparatus of claim 1, wherein the condition module continuously monitors the load state of the power supply that comprises a high load state and a low load state, and wherein the high load module and the low load module respond to a change in the state of the switching power supply.

9. The apparatus of claim 8, wherein the high load module stops supplying power to the load of the switching power supply using the high load power train in response to the condition module determining that the load state is the low load state.

10. The apparatus of claim 9, wherein the high load module stops supplying power to the load by stopping switching in the high load power train.

11. The apparatus of claim 8, wherein the low load module stops supplying power to the load of the switching power supply using the low load power train in response to the condition module determining that the load state is the high load state.

12. The apparatus of claim 11, wherein the low load module stops supplying power to the load by stopping switching in the low load power train.

13. The apparatus of claim 1, wherein the high load power train comprises magnetic elements with low direct current (“DC”) losses relative to magnetic losses and semiconductors with low drain to source resistance in the on state (“RDS(on)”) relative to inter-electrode capacitance.

14. The apparatus of claim 1, wherein the low load power train comprises magnetic elements with high DC losses relative to magnetic losses and semiconductors with high RDS(on) relative to inter-electrode capacitance.

15. A system for improving the efficiency of a switching power supply at variable load conditions, the system comprising:
a switching power supply comprising:
a high load power train comprising one or more switching power supply stages optimized for high efficiency in high power conditions;
a low load power train comprising one or more switching power supply stages optimized for high efficiency in high power conditions;
wherein only one of the high load power train and the low load power train is continuously supplying power to a load connected to the switching power supply at a time;
a condition module that determines that the switching power supply is in a high load state in response to the switching power supply supplying power to the load above a predefined power value, and that determines that the switching power supply is in a low load state in response to the switching power supply supplying power to the load below the predefined power value;
a high load module that supplies power to the load of the switching power supply using the high load power train in response to the condition module determining that the state is the high load state; and
a low load module that supplies power to the load of the switching power supply using the low load power train in response to the condition module determining that the state is the low load state.

16. The system of claim 15, wherein the switching power supply receives an input voltage that is one of an alternating current and a direct current, and wherein the switching power supply provides a regulated output voltage that is one of an alternating current and a direct current.

17. A method for improving the efficiency of a switching power supply at variable load conditions, the method comprising:
determining that a switching power supply is in a high load state in response to the switching power supply supplying power above a predefined power value;
determining that the switching power supply is in a low load state in response to the switching power supply supplying power below the predefined power value;
supplying power to a load of the switching power supply using a high load power train in response to determining that the state is the high load state, wherein the high load power train comprises one or more switching power supply stages optimized for high efficiency in high power conditions; and
supplying power to the load of the switching power supply using a low load power train in response to determining that the state is the low load state, wherein the low load power train comprises one or more switching power supply stages optimized for high efficiency in low power conditions.

18. The method of claim 18, further comprising measuring a measured power value that is one of an input current to the switching power supply, an input power to the switching power supply, an output current of the switching power supply, and an output power of the switching power supply.

19. The method of claim 19, further comprising comparing the measured power value with the predefined power value, wherein the predefined power value is a percentage of a maximum power capacity for the switching power supply.

20. The method of claim 19, further comprising continuously monitoring the state of the switching power supply and changing the power train used in the switching power supply in response to detecting a change in the state of the switching power supply.
